(19) United States
(12) Patent Application Publication
(10) Pub. No.: US 2017/0232294 A1
(43) Pub. Date: Aug. 17, 2017

(54) SYSTEMS AND METHODS FOR USING WEARABLE SENSORS TO DETERMINE USER MOVEMENTS

(71) Applicant: SensorKit, Inc., New York, NY (US)

(72) Inventors: Kenneth Kruger, Lynbrook, NY (US); Houtan Fanisalek, Jackson Heights, NY (US)

(21) Appl. No.: 15/422,911

(22) Filed: Feb. 2, 2017

Related U.S. Application Data
(60) Provisional application No. 62/295,667, filed on Feb. 16, 2016.

(51) Int. Cl. A63B 24/00; G09B 5/02; G09B 19/00; A63B 71/06

(52) U.S. Cl. CPC A63B 24/0003; A63B 71/0619; G09B 5/02; G09B 19/003; A63B 2220/836; A63B 2220/17; A63B 2071/0661

(57) ABSTRACT

Systems and methods are described that use sensors, such as accelerometers, gyroscopes or magnometers, located in wearable technology or affixed to a weight or tool. The sensors capture the motions of a user, weight or tool, and the sensor signals are analyzed to determine a list of movements, exercises and/or activities that were performed by the user, weight, or tool. An example computer-implemented method includes: receiving a signal from one or more sensors attached to an object; splitting the signal into a plurality of segments, each segment including a discrete time interval of the signal; providing one or more of the segments to a machine learning algorithm trained to recognize specific movements of the object based the signal; and receiving from the machine learning algorithm a label for each of the one or more segments, each label identifying a specific movement of the object.

### CROSS-REFERENCE TO RELATED APPLICATIONS

This application claims priority to U.S. Provisional Patent Application No. 62/295,667, filed Feb. 16, 2016, the entire contents of which are incorporated by reference herein.

### FIELD OF THE INVENTION

This disclosure generally relates to detecting and tracking movement, exercise and activity of a user wearing an electronic device equipped with one or more sensors.

### BACKGROUND

There are many devices on the market incorporating sensors, such as accelerometers and gyroscopes, that attempt to quantify a user's physical activities, movements and exercises, at least to some degree. Certain devices quantify activities such as sleep, walking, jogging and biking; however, the methods used to transform sensor data into quantified activity metrics are not accurate. In addition, current methods are unable to quantify or identify most activities that a user may perform, such as weight training, calisthenics and sport-specific movements and exercises.

### SUMMARY

The systems and methods described herein allow for the transformation of sensor data from an electronic device to a list of human recognizable exercises, movements and activities performed by the user utilizing the device. The systems and methods are more accurate and can detect and track a wider range of exercises, movements and activities than existing methods, thereby improving upon the capabilities of existing devices.

In certain examples, the systems and methods utilize software that transforms sensor data from an electronic device to a list of human recognizable movements, exercises and activities performed by the user utilizing the device. The software determines what movement, exercise or activity was performed and does not require the user to input the name of the movement, exercise, or activity beforehand. The software may display a list of human recognizable movements, exercises, and activities performed by the user. The display may be provided on a user device or may be linked to a user device and may include a timeline with associated metrics.

In certain implementations, the software determines a number of repetitions performed of each movement, exercise, or activity that has been detected by the software. The software may also determine how many sets of a given exercise were performed, as well as a resting time between movements, exercises, and activities.

In some examples, the software “learns” new movements, exercises, and activities from the user when the user inputs or modifies the software output. The user's additions to or modifications of the software output may be fed back into the software, in turn causing the software to learn to detect new movements, exercises, and activities. Alternatively or additionally, such user additions or modifications may improve the predictive accuracy for movements, exercises and activities the software already recognizes.

When the software determines that a set of movements, exercises, or activities has been completed, the software may prompt the user for additional information on the electronic device's display, associated display, or via voice recognition software. Such additional information may include, for example, a weight that was lifted in a weight training exercise and/or other metrics associated with the activities. The software may also prompt the user to confirm that the movement, exercise, or activity detected and associated metrics was indeed correct and/or allow the user to make modifications thereof on the electronic device's display, associated display, or via voice recognition software.

In certain examples, the software is initially trained to detect movements, exercises, and activities via a training process. The training process may also be used to improve the software's ability to detect movements, exercises, and activities for which the software has already been trained. During training, example data collected from users performing a given movement, exercise or activity along with relevant metrics and labels may be fed as input into the software. This allows the software to recognize or detect new movements, exercises, and activities and/or improves the ability of the software to recognize or detect movements, exercises, and activities for which the software has already been trained.

In one aspect, the subject matter of this disclosure relates to a computer-implemented method. The method includes: receiving a signal from one or more sensors attached to an object; splitting the signal into a plurality of segments, each segment including a discrete time interval of the signal; providing one or more of the segments to a machine learning algorithm trained to recognize specific movements of the object based on the signal; and receiving from the machine learning algorithm a label for each of the one or more segments, the label including an identification of a specific movement of the object.

In certain examples, the object is a person. The one or more sensors can be worn by the person. The specific movement can include an exercise performed by the person. In some implementations, the method includes determining at least one exercise parameter associated with the plurality of segments, and the at least one exercise parameter can be a number of sets, a number of repetitions, a resting time, and any combination thereof. The method can include interpolating the segments to achieve a fixed segment size. The method can include filtering the labeled segments.

In various instances, the method includes discarding a labeled segment that does not meet criteria for the label associated with the labeled segment. The method can include generating a timeline of movements for the object, the timeline including at least one label. The method can include editing the timeline based on input received from a user. The method can include using the input received from the user to train the machine learning algorithm. In some examples, the method includes training the machine learning algorithm with data from at least one sensor, the data being associated with a plurality of movements of the object. Providing one or more of the segments can include generating a feature vector for a segment and providing the feature vector to a machine learning algorithm, wherein the machine learning algorithm is trained to recognize specific movements of the object based on the feature vector.

In another aspect, the subject matter described herein relates to a system that includes one or more computers programmed to perform operations including: receiving a signal from one or more sensors attached to an object; splitting the signal into a plurality of segments, each segment including a discrete time interval of the signal; providing one or more of the segments to a machine learning algorithm trained to recognize specific movements of the object based on the signal; and receiving from the machine learning algorithm a label for each of the one or more segments, the label including an identification of a specific movement of the object.

In another aspect, the subject matter described herein relates to storage device having instructions stored thereon that when executed by one or more computers perform operations including: receiving a signal from one or more sensors attached to an object; splitting the signal into a plurality of segments, each segment including a discrete time interval of the signal; providing one or more of the segments to a machine learning algorithm trained to recognize specific movements of the object based on the signal; and receiving from the machine learning algorithm a label for each of the one or more segments, the label including an identification of a specific movement of the object.

Elements of embodiments or examples described with respect to a given aspect of the invention can be used in various embodiments or examples of another aspect of the invention. For example, it is contemplated that features of dependent claims depending from one independent claim can be used in apparatus, systems, and/or methods of any of the other independent claims.

Other aspects and advantages of the systems and methods described herein will become apparent from the following drawings, detailed description, and claims, all of which illustrate the principles of various aspects and embodiments of this disclosure, by way of example only.

### BRIEF DESCRIPTION OF THE DRAWINGS

Certain advantages of some embodiments may be understood by referring to the following description taken in conjunction with the accompanying drawings. In the drawings, like reference characters generally refer to the same parts throughout the different views. Also, the drawings are not necessarily to scale, emphasis instead generally being placed upon illustrating principles of some embodiments of the invention.

FIG. 1 is a schematic diagram of an example exercise, movement, and activity tracking system utilizing a smart phone or tablet.

FIG. 2 is a schematic diagram of an example exercise, movement, and activity tracking system utilizing a smart watch or fitness band.

FIG. 3 is a flowchart of an example method of using detection technology that operates on a signal.

FIG. 4 is a flowchart of an example method of using detection technology that operates on a signal for continuous, live detection.

FIG. 5 is a schematic diagram of an example method of transforming a signal into meaningful information.

FIG. 6 is a screenshot of an example graphical user interface showing a timeline of user activities.

FIG. 7 is a flowchart of an example method of counting repetitions, delineating sets, and determining resting times.

FIG. 8 is a flowchart of an example method of training software to detect new exercises, movements, and activities, and to improve detection accuracy.

FIG. 9 is a schematic diagram of an example method of obtaining information from a user for a user activity.

FIG. 10 is a flowchart of an example method of training software to detect new exercises, movements, and activities, and to improve detection accuracy.

FIG. 11 is a schematic diagram of an example method of modifying a value associated with a timeline item, such as a repetition count.

FIG. 12 is a schematic diagram of an example method of modifying a name of a timeline item.

FIG. 13 is a schematic diagram of an example method of adding an item to a timeline.

FIG. 14 is a schematic diagram of an example method of modifying an item in a timeline.

FIG. 15 is a schematic diagram of an example method of deleting an item from a timeline.

### DETAILED DESCRIPTION

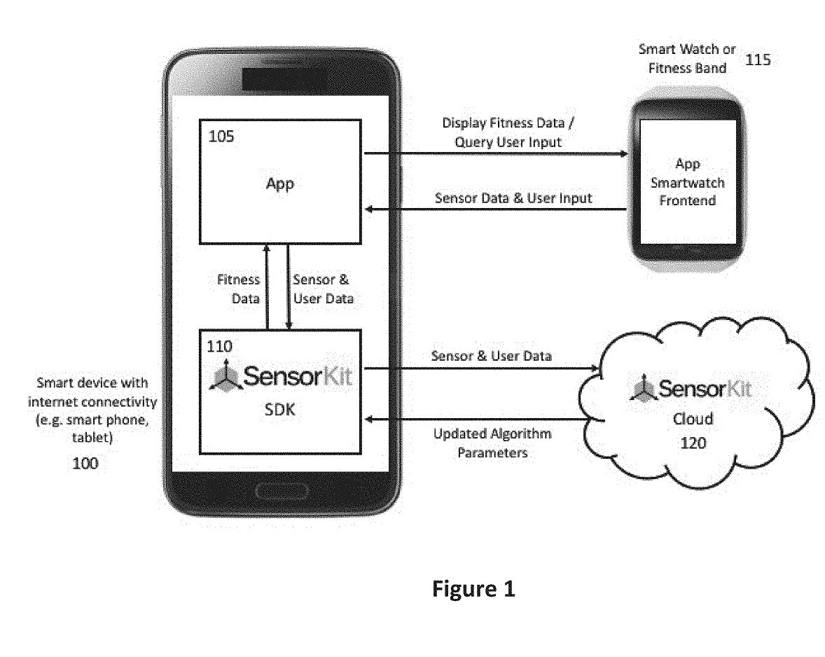

FIG. 1 shows one embodiment of a smart watch or fitness band 115 that is worn by a user while performing exercises, movements, and/or activities. The smart watch or fitness band 115 sends sensor data and user input to a smart device 100 with internet connectivity, such as a smart phone or tablet. An app 105 residing on the smart device 100 facilitates communication with the smart watch or fitness band 115 and forwards sensor data and user input to software 110. The software 110, upon receiving sensor and user data will translate the data into meaningful fitness data. The fitness data will be sent back to the app 105 for additional processing and display to the user and may also be sent back to the smart watch or fitness band 115 for display and to request user feedback. Additionally, the software 110 may send sensor and user data to a cloud server 120 for further processing and analysis. This may lead to updated algorithm parameters and other software updates that may be sent from the cloud server 120 to the software 110. In a preferred embodiment, a Software Development Kit (SDK) provides an API to developers who may use the API to interface with the systems and methods. Alternatively, embodiments are provided where the SDK and API abstraction layers are not present and the systems and methods are tightly coupled with surrounding software and hardware.

In general, the exercises, movements, and/or activities may be any type of exercises, movements, and/or activities that can be measured with one or more sensors (e.g., including a wearable sensor) and analyzed using the systems and methods described herein. The exercises, movements, and/or activities may be or include, for example, weight lifting, running, walking, dancing, aerobics, stretching, sports activities (e.g., basketball, hockey, or soccer), manual labor activities (e.g., swinging a hammer), and/or one or more gestures.

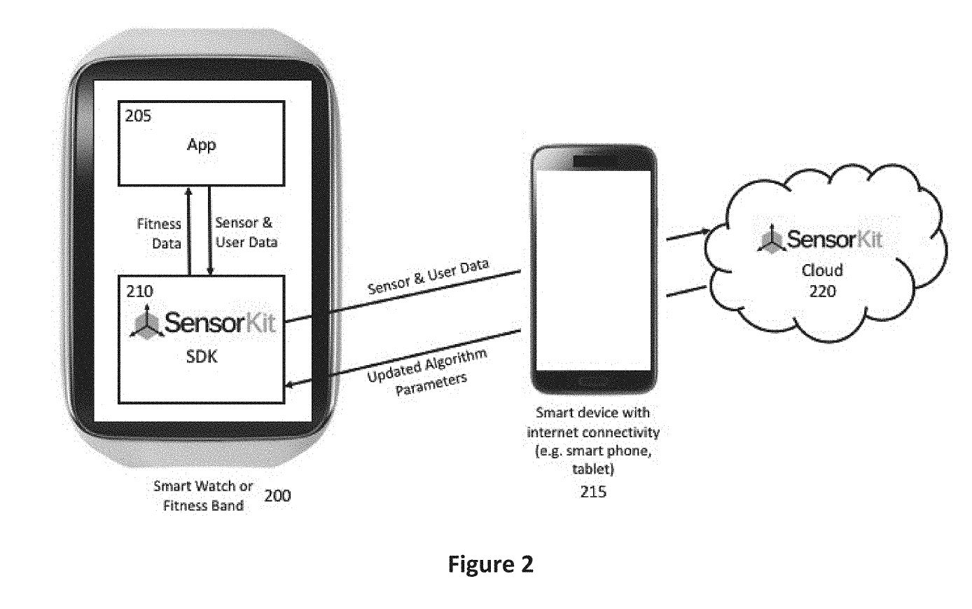

FIG. 2 shows another embodiment in which a smart watch or fitness band 200 is worn by a user while performing exercises, movements and/or activities. The smart watch or fitness band 200 generates sensor data that is read by an app 205 residing on the fitness band 200. The app 205 may also request input from the user. The app 205 sends both sensor data and user input to software 210. The software 210 then translates this data into meaningful fitness data, which is then sent back to the app 205 for further processing and/or display to the user. Additionally or alternatively, the software 210 may send sensor and user data to a cloud server 220 for further processing and analysis. This may lead to updated algorithm parameters and other software updates that may be sent from the cloud server 220 to the software 210. The transmission of data to and from the software 210 and the cloud server 220 may or may not occur via passing through a smart device 215 with internet connectivity, such as a smart phone or tablet. In some embodiments, the smart watch or fitness band 200 has internet connectivity and will not need to transmit data to the cloud server 220 via a smart device 215. In a preferred embodiment, a Software Development Kit (SDK) provides an API to developers who may use the API to interface with the systems and methods. Alternatively, embodiments are provided where the SDK and API abstraction layers are not present and the systems and methods are tightly coupled with surrounding software and hardware.

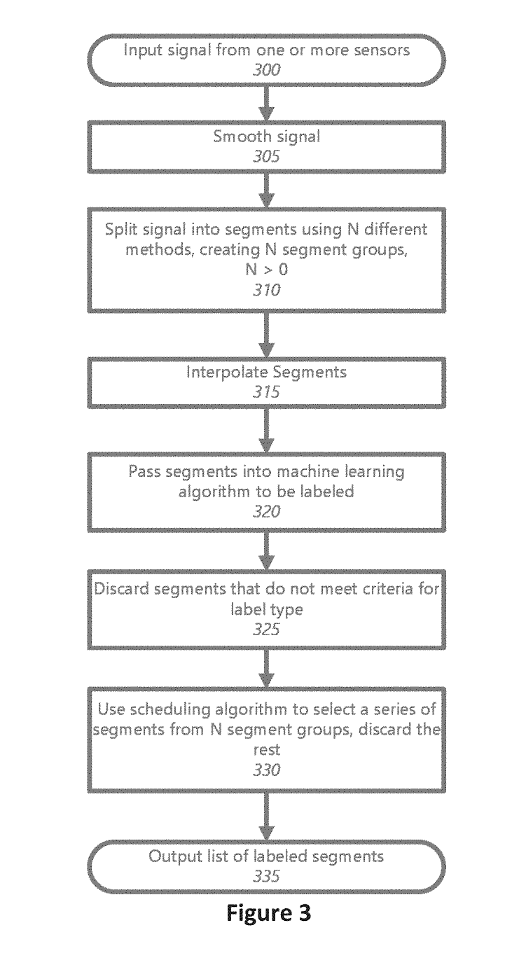

FIG. 3 is a flowchart illustrating an example method of using software detection technology to operate on a signal 300 from one or more sensors (also referred to as “sensor data”) to translate the signal 300 into a list of labeled segments 335. A labeled segment is a portion of the input signal 300 with an associated label, such as “pushup” in the case of a user performing a pushup. A list of labeled segments 335 refers to a list of these labeled segments. In certain examples, a segment is an interval of time. The time interval may be, for example, 0.5 seconds, 1 second, 2 seconds, or 5 seconds. In general, a segment is a portion of a signal over a specific time interval. In preferred examples, a segment is an n-dimensional time series of any length. For example, a segment may be a portion of an input signal from t₁=1.5 seconds to t₂=4.5 seconds.

The first step in translating the input signal 300 to a list of labeled segments 335 is to prepare the data by smoothing the signal (step 305). The smoothing step 305 acts to reduce noise in the input signal 300 and may be performed via a variety of methods and options based on the input signal 300 and the type of sensors from which the input signal 300 is generated. Smoothing methods include, but are not limited to, moving average, Kalman filter, and/or interpolating spline. The input parameters besides the input signal 300 to these smoothing methods may be adjusted or varied. Such input parameters include, for example, a window size of moving average, Kalman filter parameters, and a number of polynomials when interpolating splines.

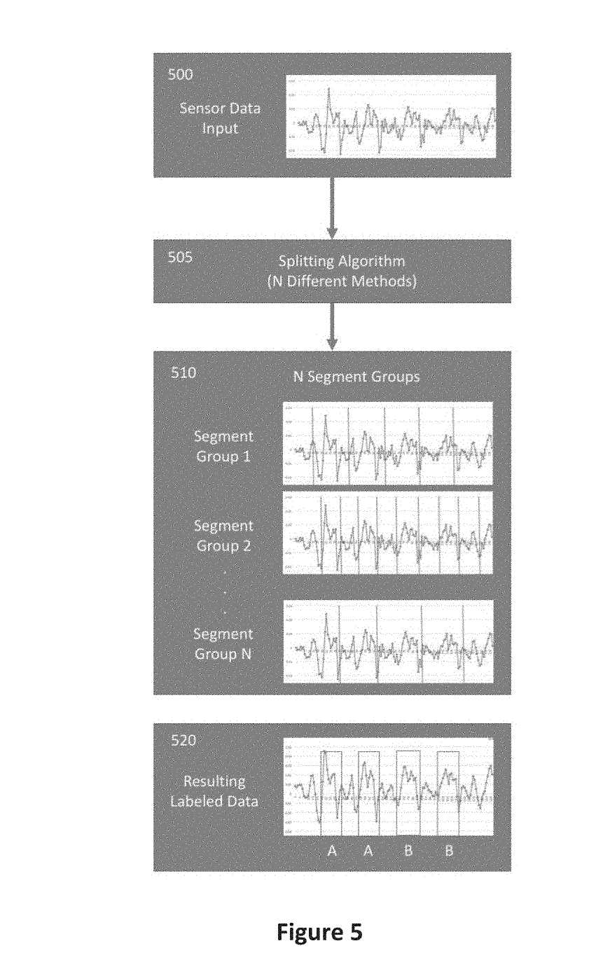

Following the signal smoothing step 305, the smoothed signal is split (step 310) N different ways into N groups of segments, where N>0. This splitting process is illustrated in FIG. 5. Sensor data input 500 feeds into the splitting algorithm 505, which contains N different methods of splitting the sensor data 500 into segments. The output of a splitting method is a segment group, which includes a list of segments (subsequences of the multivariate input signal). The N splitting methods 505 collectively generate N segment groups 510, where splitting method i generates segment group i, where 0<i<N+1. FIG. 5 illustrates the N segment groups 510, by delineating with vertical lines the input signal. Each sub-sequence of the sensor data between two vertical lines represents a segment in the segment group. The N splitting methods may be or include, for example, fixed distance, Fourier Transform, Short-Time Fourier Transform, Wavelet transform, and/or Peak analysis. The N splitting methods may also be or include multiple versions of the same splitting method, but with varying parameters. For example, fixed distance where the distance is 20, 30, or 40 may be considered three different splitting methods.

Referring again to FIG. 3, following splitting the signal at step 310, the segments from all N segment groups 510 are interpolated (step 315). Interpolation is used to prepare the segments for input into a machine learning algorithm at step 320. Segments are preferably interpolated to a fixed size determined by the nature of the exercises, movements, and activities the software is to detect. For example, if it is known that the set of exercises, movements or activities to be detected have few intricacies, will be short in duration, and no two look alike when the segments are inspected, the interpolation size may be small, such as 40 sample points. If the set is large, unknown beforehand, has elements that may be long in duration, or has data with many unique features that are necessary to differentiate between two segments of different types, the interpolation size may be larger, such as 100 sample points. The primary purpose of interpolating the segments is to standardize the size of the segments (e.g., in length of time or number of data points) as many machine learning algorithms require all input data to be of the same size. Interpolation may also, in some cases, allow for faster computations and lower power usage, as using a smaller interpolation size generally requires less processing in later steps, compared to processing required when using a larger interpolation size. Interpolation may be performed via a variety of methods and options, including, for example, linear, polynomial, and/or spline interpolation. A preferred embodiment uses linear interpolation.

In the case of an M-dimensional signal, each of the M dimensions may be interpolated separately and then combined via concatenation in some predefined order to create a 1-dimensional segment. An example of an M-dimensional signal would be a 3-axis accelerometer and a 3-axis gyroscope together generating a 6-dimensional signal. In an alternative implementation, each label type may have its own interpolation size and there may be separate machine learning algorithms to accept segments of each interpolation size to provide labels. For example, a 3-dimensional signal from an accelerometer that is 2 seconds in duration at a 20 hz rate has 40 sample points in each of the three dimensions, X, Y and Z. If, for instance, the interpolation size was 50 sample points, each dimension would be interpolated from 40 sample points to 50 sample points. Following interpolation, if, for instance, the predefined order of concatenation was to attach the Y dimension data to the end of the X dimension data and the Z dimension data to the end of the Y dimension data, the three dimensions of data would be concatenated to create one segment of length 150 sample points comprising the interpolated X data followed by the interpolated Y data followed by the interpolated Z data.

Following segment interpolation at step 315, the interpolated segments are fed into a machine learning algorithm to be labeled (step 320). The segments may either be input into the machine learning algorithm one at a time, or in batches. In general, this step requires that the machine learning algorithm already be trained with exercise, movement, or activity data, as described herein, in order for that exercise, movement, or activity to be detected. The data used to train the machine learning algorithm preferably includes data from previous exercises, movements, and activities performed by the user, another user or generated via a computer simulation. The data may include, for example, a sensor signal along with a label, such as “Push Up”.

The machine learning algorithm preferably detects or identifies an exercise, movement, or activity associated with each segment and then labels the segment according to the exercise, movement, or activity. For each segment input to the machine learning algorithm, the machine learning algorithm provides a label associated with the segment. For example, a number of segments may be input to a machine learning algorithm as a matrix, where each row in the matrix contains data for a different segment. In that case, the machine learning algorithm may output a vector of labels, where each element i in the label vector is associated with row i in the input matrix. Machine learning may be performed using a variety of methods and options. In one implementation, the machine learning algorithm may output, for each input segment, a list of labels along with numeric values representative of how likely a segment is to be a classified by each label. A numeric value may be or represent, for example, a confidence score associated with a likelihood that the label is correct for a given segment. In some instances, the numeric values may be measures of similarity or distance between the input segment and segments with which the machine learning algorithm has already been trained and therefore already have associated labels. If, for example, a segment has a similarity value below a certain threshold for all labels, the segment may be relabeled as “nothing” as it does not sufficiently look like any exercise, movement or activity with which the machine learning algorithm has been trained. Example machine learning algorithms include, but are not limited to, K Nearest Neighbors, Support Vector Machine, and Neural Network. Parameters and options for the selected machine learning algorithm may be determined by the nature of the signal 300 and sensors utilized. A preferred embodiment uses a Neural Network machine learning algorithm.

In certain implementations, following the labelling step 320, the labeled segments are filtered, and segments that do not meet criteria for their label are discarded (step 325). This process is intended to reduce false positives after the labeling step 320. The criteria checked for each label may include, for example, duration, variance, distance, and similarity metrics, and other statistics that may be associated with multivariate signals. The filtering step 325 may provide thresholds for each label type and each criterion, such that a segment with a criterion falling outside the threshold may be discarded. For example, a label “Lunge” may have the criterion that a segment must be less than 5 seconds in duration and therefore a segment labeled “Lunge” with duration 10 seconds would be discarded in this step (325). Another example would be a label “Lunge” having the criterion that a segment must have similarity value above 0.9 (on a scale of 0 to 1), and therefore a segment of label “Lunge” with similarity value below 0.9 would be discarded in this step (325).

Following the filtering step 325, a scheduling algorithm is used to select (step 330) a series of segments from the N segment groups as a final list of labeled segments 335. This scheduling step 330 acts to select a number of segments that best match the criteria for their given labels and do not conflict with each other. For example, a segment from time 3 to time 8 may be labeled “pushup” and a segment from time 5 to time 10 may be labeled “sit-up.” These segments conflict because they overlap in time and a user cannot perform both a pushup and sit-up simultaneously. In such an instance, the scheduling algorithm may select the segment that was most likely performed based on criteria for their given labels as well as contextual data, such as the exercises, movements and activities performed before or after the segments under consideration. Referring once again to FIG. 5, the final list of labeled segments includes the resulting labeled data 520 and is, in the illustrated example, a subset of segments from segment group 2 (from 510). The segments are labeled with either label “A” or label “B”.

In certain implementations, instead of segments being input to the machine learning algorithm directly, as described herein, a feature vector is generated for each segment and input to the machine learning algorithm. The feature vector for a segment is preferably a vector that includes values calculated from data associated with the segment. The feature vector may include, for example, a mean, a variance, a duration, a derivative, a slope, a peak count, and/or other calculated values for the segment. In one example, the feature vector is calculated before interpolation, bypassing the interpolation step altogether, or after interpolation, using the interpolated segment as a basis for calculating the feature vector.

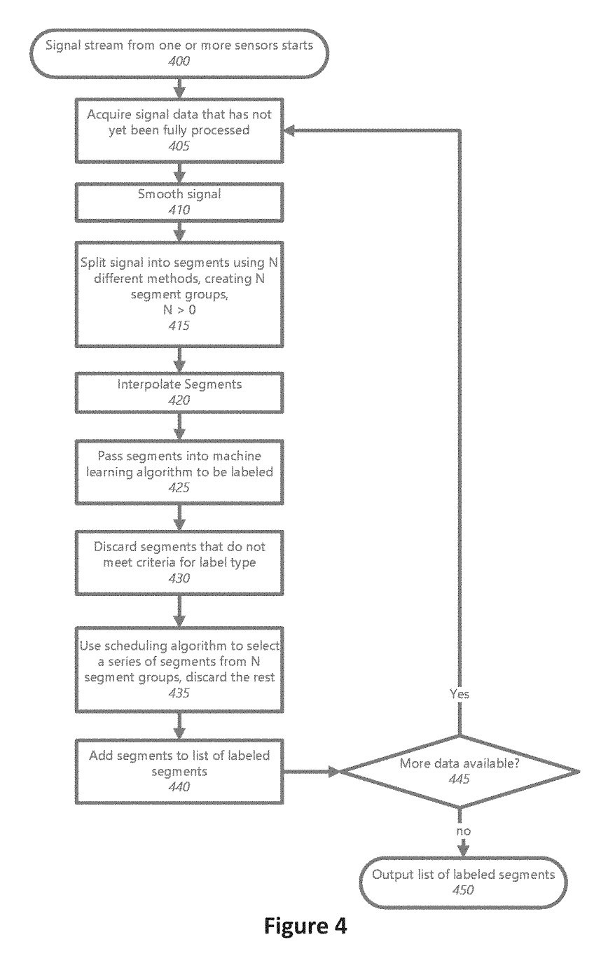

FIG. 4 is a flowchart illustrating an example method of using software detection technology to operate on a signal 400 from one or more sensors (also referred to as “sensor data”) to translate the signal 400 into a list of labeled segments 450, in a continuous, live manner. A labeled segment is a portion of the input signal 400 with an associated label, such as “pushup” in the case of a user performing a pushup. A list of labeled segments 450 refers to a list of these labeled segments. In certain examples, a segment is an interval of time. The time interval may be, for example, 0.5 seconds, 1 second, 2 seconds, or 5 seconds. In general, a segment is a portion of a signal over a specific time interval. In preferred examples, a segment is an n-dimensional time series of any length. For example, a segment may be a portion of an input signal from t₁=1.5 seconds to t₂=4.5 seconds.

The first step in translating the input signal 400 to a list of labeled segments 450 is to split the input signal into a sub-signal comprising the data that has not yet been processed (step 405). This sub-signal is then prepared by smoothing the signal (step 410). The smoothing step 410 acts to reduce noise in the sub-signal 405 and may be performed via a variety of methods and options based on the sub-signal 405 and the type of sensors from which the input signal 400 is generated. Smoothing methods include, but are not limited to, moving average, Kalman filter, and/or interpolating spline. The input parameters besides the input sub-signal 405 to these smoothing methods may be adjusted or varied. Such input parameters include, for example, a window size of moving average, Kalman filter parameters, and/or a number of polynomials when interpolating splines.

Following the signal smoothing step 410, the smoothed signal is split (step 415) N different ways into N groups of segments, where N>0. An example splitting process is illustrated in FIG. 5. Sensor data input 500 feeds into the splitting algorithm 505, which contains N different methods of splitting the sensor data 500 into segments. The output of a splitting method is a segment group, which includes a list of segments (subsequences of the multivariate input signal). The N splitting methods 505 collectively generate N segment groups 510, where splitting method i generates segment group i, where 0<i<N+1. FIG. 5 illustrates the N segment groups 510, by delineating with vertical lines the input signal. Each sub-sequence of the sensor data between two vertical lines represents a segment in the segment group. The N splitting methods may be or include, for example, fixed distance, Fourier Transform, Short-Time Fourier Transform, Wavelet transform, and/or Peak analysis. The N splitting methods may also be or include multiple versions of the same splitting method, but with varying parameters. For example, fixed distance where the distance is 20, 30, or 40 may be considered three different splitting methods.

Referring again to FIG. 4, following splitting the signal at step 415, the segments from all N segment groups 510 are interpolated (step 420). Interpolation is used to prepare the segments for input into a machine learning algorithm at step 425. Segments are preferably interpolated to a fixed size determined by the nature of the exercises, movements, and activities the software is to detect. For example, if it is known that the set of exercises, movements or activities to be detected have few intricacies, will be short in duration, and no two look alike when the segments are inspected, the interpolation size may be small, such as 40 sample points. If the set is large, unknown beforehand, has elements that may be long in duration, or has data with many unique features that are necessary to differentiate between two segments of different types, the interpolation size may be larger, such as 100 sample points. The primary purpose of interpolating the segments is to standardize the size of the segments (e.g., in length of time or number of data points) as many machine learning algorithms require all input data to be of the same size. Interpolation may also, in some cases, allow for faster computations and lower power usage, as using a smaller interpolation size generally requires less processing in later steps, compared to processing required when using a larger interpolation size. Interpolation may be performed via a variety of methods and options, including, for example, linear, polynomial, and/or spline interpolation. A preferred embodiment uses linear interpolation.

In the case of an M-dimensional signal, each of the M dimensions may be interpolated separately and then combined via concatenation in some predefined order to create a 1-dimensional segment. An example of an M-dimensional signal would be a 3-axis accelerometer and a 3-axis gyroscope together generating a 6-dimensional signal. In an alternative implementation, each label type may have its own interpolation size and there may be separate machine learning algorithms to accept segments of each interpolation size to provide labels. For example, a 3-dimensional signal from an accelerometer that is 2 seconds in duration at a 20 hz rate has 40 sample points in each of the three dimensions, X, Y and Z. If, for instance, the interpolation size was 50 sample points, each dimension would be interpolated from 40 sample points to 50 sample points. Following interpolation, if, for instance, the predefined order of concatenation was to attach the Y dimension data to the end of the X dimension data and the Z dimension data to the end of the Y dimension data, the three dimensions of data would be concatenated to create one segment of length 150 sample points comprising the interpolated X data followed by the interpolated Y data followed by the interpolated Z data.

Following segment interpolation at step 420, the interpolated segments are fed into a machine learning algorithm to be labeled (step 425). The segments may either be input into the machine learning algorithm one at a time, or in batches. In general, this step requires that the machine learning algorithm already be trained with exercise, movement, or activity data, as described herein, in order for that exercise, movement, or activity to be detected. The data used to train the machine learning algorithm preferably includes data from previous exercises, movements, and activities performed by the user, another user or generated via a computer simulation. The data may include, for example, a sensor signal along with a label, such as “Push Up”.

The machine learning algorithm preferably detects or identifies an exercise, movement, or activity associated with each segment and then labels the segment according to the exercise, movement, or activity. For each segment input to the machine learning algorithm, the machine learning algorithm provides a label associated with the segment. For example, a number of segments may be input to a machine learning algorithm as a matrix, where each row in the matrix contains data for a different segment. In that case, the machine learning algorithm may output a vector of labels, where each element i in the label vector is associated with row i in the input matrix. Machine learning may be performed using a variety of methods and options. In one implementation, the machine learning algorithm may output, for each input segment, a list of labels along with numeric values representative of how likely a segment is to be a classified by each label. A numeric value may be or represent, for example, a confidence score associated with a likelihood that the label is correct for a given segment. In some instances, the numeric values may be measures of similarity or distance between the input segment and segments with which the machine learning algorithm has already been trained and therefore already have associated labels. If, for example, a segment has a similarity value below a certain threshold for all labels, the segment may be relabeled as “nothing” or “indeterminate” as it does not sufficiently look like any exercise, movement or activity with which the machine learning algorithm has been trained. Example machine learning algorithms include, but are not limited to, K Nearest Neighbors, Support Vector Machine, and Neural Network. Parameters and options for the selected machine learning algorithm may be determined by the nature of the signal 400 and sensors utilized. A preferred embodiment uses a Neural Network machine learning algorithm.

In certain implementations, following the labelling step 425, the labeled segments are filtered, and segments that do not meet criteria for their label are discarded (step 430). This process is intended to reduce false positives after the labeling step 425. The criteria checked for each label may include, for example, duration, variance, distance, and similarity metrics, and other statistics that may be associated with multivariate signals. The filtering step 430 may provide thresholds for each label type and each criterion, such that a segment with a criterion falling outside the threshold may be discarded. For example, a label “Lunge” may have the criterion that a segment must be less than 5 seconds in duration and therefore a segment labeled “Lunge” with duration 10 seconds would be discarded in this step (430). Another example would be a label “Lunge” having the criterion that a segment must have similarity value above 0.9 (on a scale of 0 to 1), and therefore a segment of label “Lunge” with similarity value below 0.9 would be discarded in this step (430).

Following the filtering step 430, a scheduling algorithm is used to select (step 435) a series of segments from the N segment groups to add to the final list of labeled segments 440. This scheduling step 435 acts to select a number of segments that best match the criteria for their given labels and do not conflict with each other. For example, a segment from time 3 to time 8 may be labeled “pushup” and a segment from time 5 to time 10 may be labeled “sit-up.” These segments conflict because they overlap in time and a user cannot perform both a pushup and sit-up simultaneously. In such an instance, the scheduling algorithm may select the segment that was most likely performed based on criteria for their given labels as well as contextual data, such as the exercises, movements and activities performed before or after the segments under consideration. Referring once again to FIG. 5, the final list of labeled segments includes the resulting labeled data 520 and is, in the illustrated example, a subset of segments from segment group 2 (from 510). The segments are labeled with either label “A” or label “B”.

After the segments output from the scheduling algorithm (step 435) are added to the final list of labeled segments (step 440), if there is more data available that has not yet been processed (step 445), the process repeats again, starting by acquiring the sub-signal of the input signal that has yet to be processed (step 405). If no data remains in the input signal, the process is complete and the list of labeled segments 450 contains the labeled segments that were added in each iteration of step 440.

In certain implementations, instead of segments being input to the machine learning algorithm directly, as described herein, a feature vector is generated for each segment and input to the machine learning algorithm. The feature vector for a segment is preferably a vector that includes values calculated from data associated with the segment. The feature vector may include, for example, a mean, a variance, a duration, a derivative, a slope, a peak count, and/or other calculated values for the segment. In one example, the feature vector is calculated before interpolation, bypassing the interpolation step altogether, or after interpolation, using the interpolated segment as a basis for calculating the feature vector.

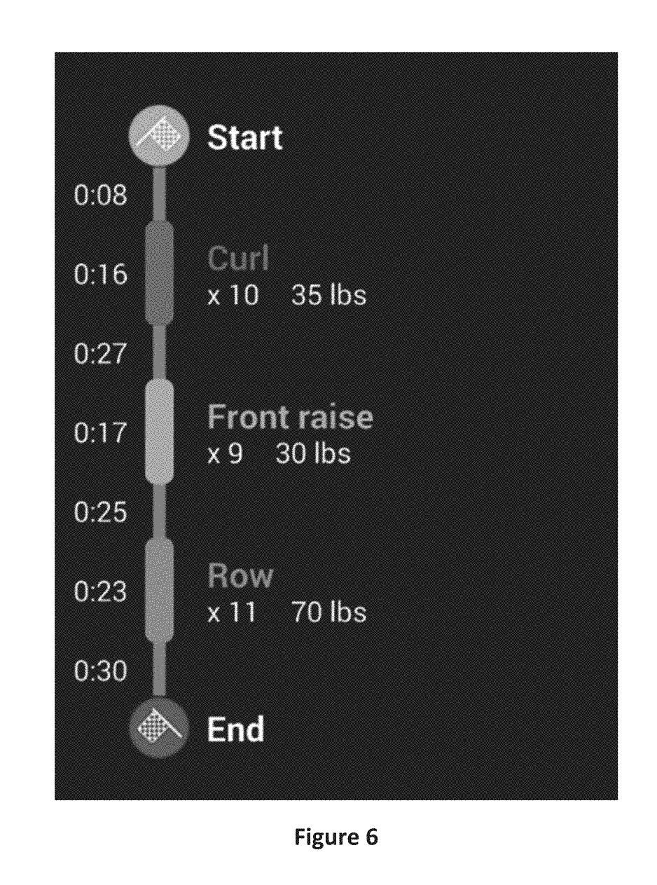

FIG. 6 shows one embodiment of a display of detected exercises, hereafter referred to as a timeline. In this embodiment, the most recent exercises, movements and activities are displayed at the bottom of the timeline. The timestamps on the left represent durations. The rounded rectangles on the timeline represent an activity or a set of exercises or movements, next to each of which is displayed the name/label of the exercise, movement or activity and associated metrics. Associated metrics include, for example, repetitions for exercises, movements and activities that may be repeated, and weight for exercises, movements and activities that require some sort of weight to perform. For example, in the embodiment shown in FIG. 6, the first rounded rectangle represents a set of curls with associated metrics of 10 repetitions and 35 lbs. Spaces between the rounded rectangles on the timeline represents the absence of exercises, movements and activities and in the case of certain exercise activities, may be displayed to the user as the resting time between exercise sets.

In one embodiment, the timeline is long and is displayed to the user piecewise on a display, allowing the user to scroll vertically through the entirety of the timeline. In one embodiment of the timeline, each rounded rectangle is color coded according to the exercise, movement or activity name/label. In one example, the most recent exercises, movements and activities are displayed at the top of the timeline.

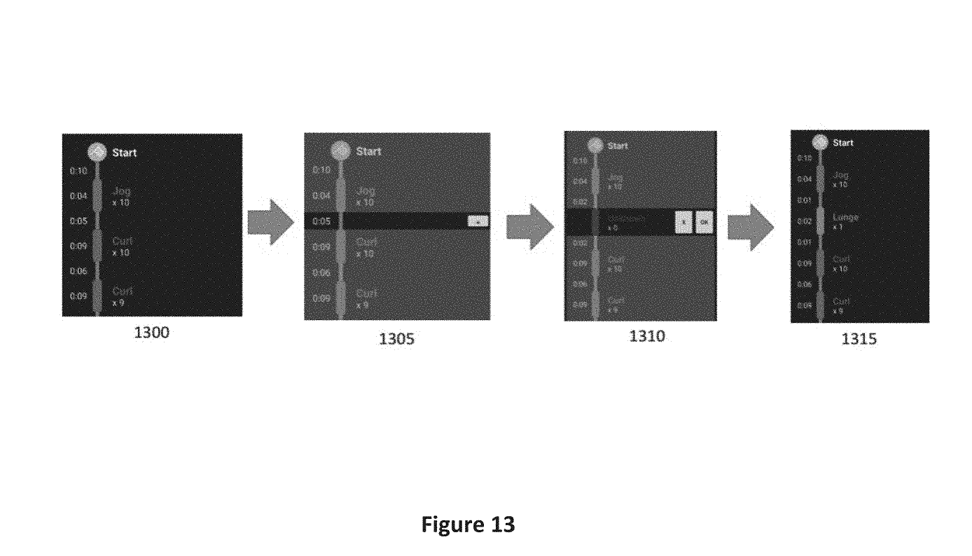

FIGS. 13, 14, and 15 illustrate how a user may interact with preferred embodiments of the timeline to make corrections, additions, and/or deletions, as desired. This user input is fed back into the systems and methods (e.g., the machine learning algorithms) so that the systems and methods may learn to better detect and classify exercises, movements and activities. Such user input may also be sent to servers so that users may benefit from the classification improvements provided from all other users.

FIG. 13 illustrates an example method in which a user may add an exercise to a timeline in a user interface 1300. An “add” button is displayed in a particular resting area when the user taps, long presses, swipes or provides some other interaction or gesture with user interface 1305 in the resting area. A preferred method for displaying the “add” button includes a long press. The resting area within which the “add” button is displayed is the area within which a new exercise, movement or activity may now be added. The user may dismiss the “add” button by tapping outside the resting area with the “add” button. In another implementation, an “add” button is always present on each resting area and no interaction with the user interface is required for the button to be displayed.

When the user taps the “add” button, a new input area is displayed between two resting areas as shown in user interface 1310, thereby replacing the resting area with the “add” button. In the embodiment illustrated, a new exercise, movement or activity is set by default to “unknown” with repetition count “0.” The user may enter an exercise, movement or activity name with associated metrics, such as repetition count and weight via standard user input methods such as an onscreen keyboard, physical keyboard or voice command. The inputs may be prepopulated with a guess as to what the user may want to enter based on previous exercises, movements or activities the user has performed or based on analysis of the underlying sensor data. In one embodiment, the user may be presented with a list of most likely exercises, movements and activities, from which the user may select, based on previous exercises, movements or activities the user has performed or based on analysis of the underlying sensor data. The user may select the “cancel” button, represented in user interface 1310 as a button with an “x,” to not add a new item to the timeline and return to the timeline shown in user interface 1300. In one embodiment, the user may cancel the addition by tapping elsewhere on the screen or taking another action to indicate cancellation. The user may select the “confirm” button, represented in user interface 1310 by a button with text “ok,” to add the new item to the timeline.

For purposes of illustration in FIG. 13, the user entered “Lunge” as the activity and “1” as the repetition count in the input fields in user interface 1310 and upon pressing the “confirm” button, the timeline displayed in user interface 1315 has a Lunge activity of 1 repetition, in a location where the user tapped the add button. In one example, confirming may be indicated by the user by tapping elsewhere on the screen or taking another action indicating confirmation.

In certain embodiments, an “add” button is not displayed on the user interface 1300 and, instead, a new exercise, movement or activity input area is displayed immediately following the user interaction with a particular resting area, thereby circumventing the “add” button step in user interface 1305.

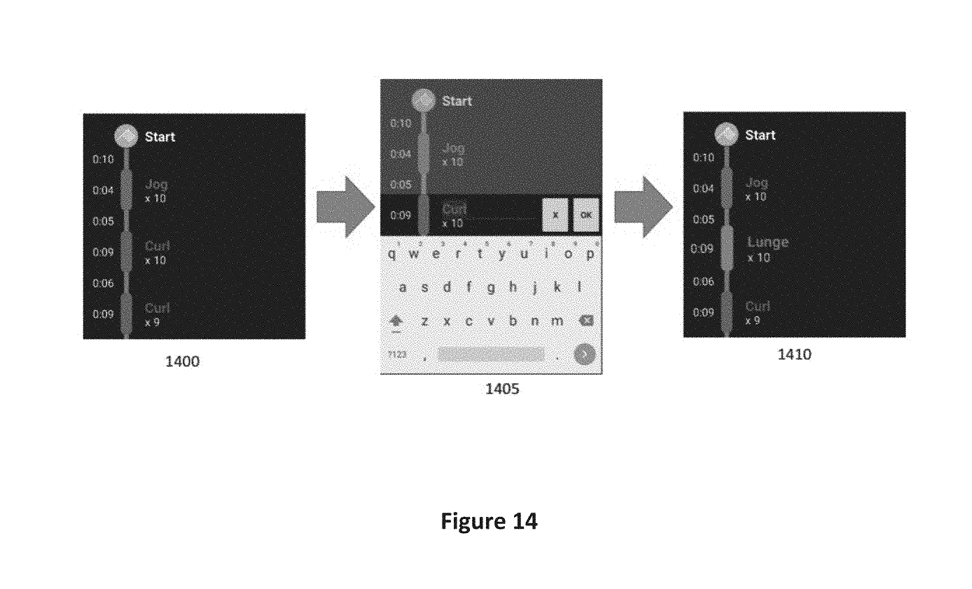

FIG. 14 illustrates an example method in which a user may modify the contents (e.g., labelling and/or metrics) of an exercise, movement or activity on a timeline. The user may modify the contents of an exercise, movement or activity by tapping, long pressing, swiping or indicating through some other interaction with a user interface 1400 at a particular item on the timeline. Upon tapping the item, the name of the exercise, movement or activity as well as associated metrics, such as repetition count and weight, may be modified via standard input methods such as a keyboard, onscreen keyboard or voice command, as shown in user interface 1405. The user may select a “cancel” or “x” button to not apply modifications to the item and return to the timeline's state prior to initiating the modify action. In one example, cancelling is indicated by the user by tapping elsewhere on the screen or taking another action indicating cancellation. The user may select the “confirm” or “OK” button to add the new information to the item on the timeline. For purposes of illustration in user interface 1410, the user entered “Lunge” as the activity name and did not modify the repetition count and, upon pressing the “OK” button, the timeline displays a Lunge activity of 10 repetitions, where there was originally a curl activity of 10 repetitions, in user interface 1400. In some implementations, confirming may be indicated by the user by tapping elsewhere on the screen or taking another action indicating confirmation.

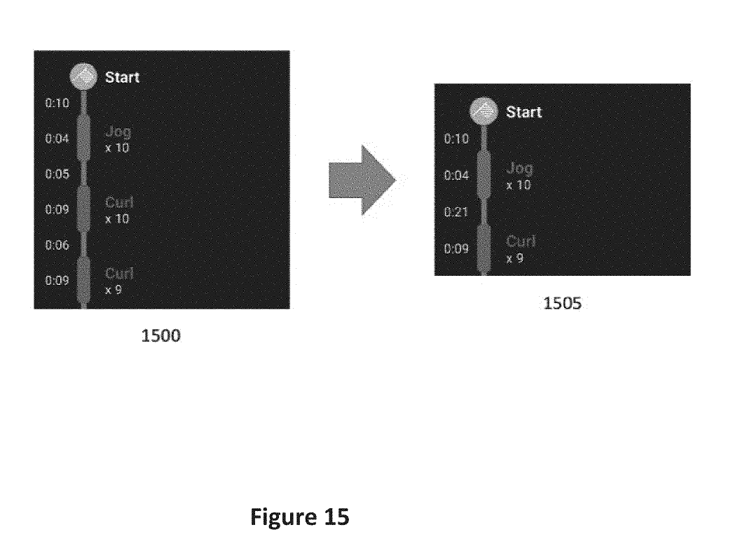

FIG. 15 illustrates an example method with which a user may delete an exercise, movement or activity from a timeline. In one embodiment, the user may delete an exercise, movement or activity by tapping, long pressing, swiping or indicating through some other interaction with the user interface at a particular item on the timeline in user interface 1500. A preferred approach involves swiping to the left on the item. In one embodiment, the user swipes left on an item which causes a “delete” button to appear for the item. The user may then select the delete button to delete the item. In the depicted example, user interface 1505 indicates a user has deleted an item (i.e., 10 curls) on the timeline from user interface 1500.

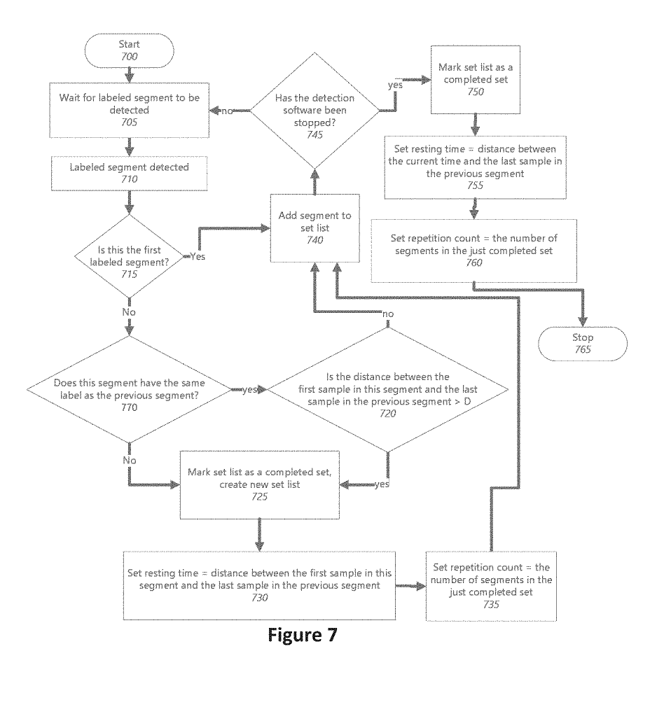

FIG. 7 is a flowchart illustrating how the systems and methods determine the number of repetitions a user has performed of an exercise, movement or activity and how sets of those exercises, movements and activities are delineated. In certain embodiments, a set is a number of repetitions where both prior to and after the repetitions one of the following holds: 1) a fixed amount of time passes where no movements, exercises or activities are detected by the software, or 2) additional movements, exercises or activities performed within a fixed amount of time from said repetitions are of a different type than those in said repetitions.

In one embodiment, the systems and methods described herein (e.g., as implemented with software and one or more processors) start (step 700) the process of counting repetitions and delineating sets while the detection process described in FIG. 3 or FIG. 4 is started. A labeled segment is detected (step 705) and, upon detecting the labeled segment (step 710), the systems and methods check to see if the labeled segment is the first one to be processed (step 715). If the labeled segment is the first one to be processed, the labeled segment is added to the current set list (step 740) and, as long as the detection software has not been stopped 745, the software waits for the next labeled segment to be detected (step 705). A set list is a list of labeled segments that contains labeled segments that are all in the same set.

Otherwise, if the segment was not the first labeled segment, the software checks to see if the segment and the previously detected segment have the same label type (step 770). If this is the case, the software then determines if the distance between the first sample in the segment and the last sample in the previously detected segment is greater than some threshold distance D (step 720). D is a maximum distance allowed between two neighboring segments of the same label type in order for those two segments to be considered in the same set. D is preferably a configurable parameter and may be, for example, 1 second, 2 seconds, or 5 seconds. If the distance between these two segments is less than or equal to D, the segment is added to the current set list (step 740) and, as long as the detection software has not been stopped (step 745), the software waits for the next labeled segment to be detected (step 705).

If either the segment and previously detected segment have different labels (step 770) or the distance between the two segments (step 720) is greater than threshold distance D, the software may mark the current set list as a completed set and create a new set list (step 725). The software will then set or determine the value of the resting time between the set list that was just completed and a new set list (step 730). The repetition count of the set list that was just completed may be set or determined (step 735). The segment is added to the new set list (step 740) and, if the detection software has not been stopped (step 745), the software waits for the next labeled segment to be detected (step 705).

If the detection software is stopped 745, the systems and methods may assume all segments have been processed into sets. Thus, the software may mark the current set list as a completed set (step 750). The software will then set the value of the resting time between the set list that was just completed and the end of the workout session (step 755) and/or set the repetition count of the set list that was just completed (step 760) before stopping (step 765).

In certain embodiments, the software (i.e., as implemented with one or more processors) starts (step 700) the process of counting repetitions and delineating sets following the process described in FIG. 3 or FIG. 4 as a way to “post process” data that has already been collected. In this case, waiting for an additional labeled segment to be detected (step 705) does not need to occur since the segment has already been detected and the requisite data is already available. Additionally or alternatively, checking the condition of the detection software having been stopped (step 745) may be replaced by checking to see if there is any data remaining in the dataset that was generated by a previous run of the process described in FIG. 3 or FIG. 4.

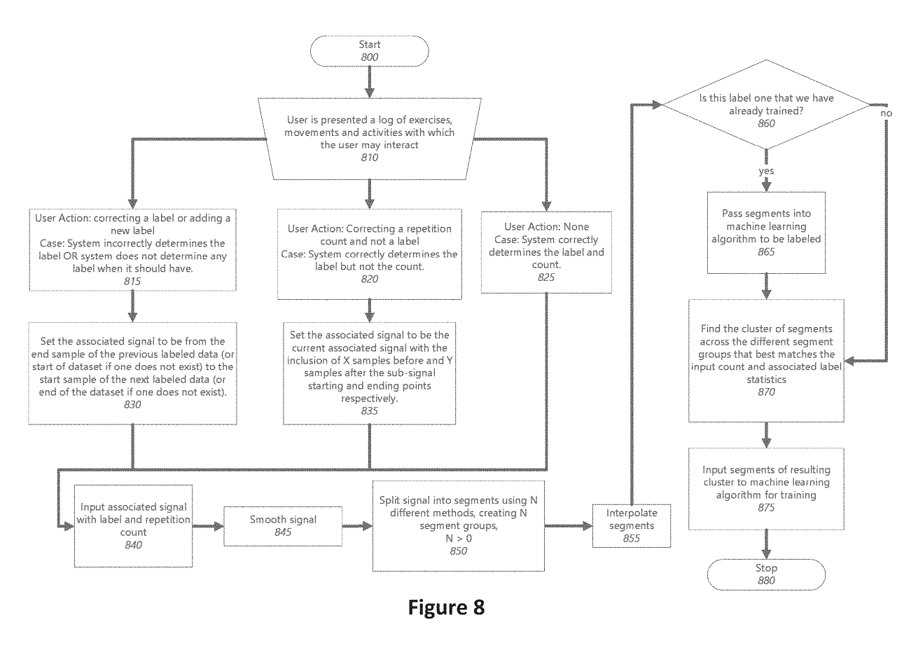

FIG. 8 is a flowchart illustrating an example method of how the systems and methods learn how to detect exercises, movements and activities that had not previously been detected and how the systems and methods are able to become more accurate at detecting the exercises, movements and activities. This process starts (step 800) with the user being presented with a log of exercises, movements and activities with which the user may interact (step 810). In one embodiment, the log is presented as a timeline as in FIG. 6. Based on the user's interaction with the log of exercises, movements and activities, the software may take different actions to learn.

If the user corrects the label of an exercise, movement or activity in the log (step 815), this signals to the software that it did not correctly label that exercise, movement or activity. If the user adds/inserts a new label of an exercise, movement or activity in the log (step 815), this signals to the software that it did not detect said exercise, movement or activity. In either of these two cases, the software will isolate the sensor signal(s) that may be associated with the missing or incorrect label. To do this, the associated signal may be set to be from the end sample of the previous labeled data (or start of the dataset if one does not exist) to the start sample of the next labeled data (or end of the dataset if one does not exist) (step 830). The associated signal is then combined with the label the user added or modified along with a repetition count which may or may not have been modified by the user (step 840).

If the user corrects a repetition count of an exercise, movement or activity, and does not modify the label associated with said exercise, movement or activity (step 820), the software may isolate the associated signal. This may be done by setting the associated signal to the signal already associated with that particular set of exercise, movement or activity, but with the inclusion of X samples before and Y samples after the the original associated signal(s) start and end points, respectively (step 835). The associated signal is then combined with the label along with the repetition count modified by the user 840. Here, X and Y are parameters that may be set based on the amount of data one may wish to collect and/or may be based on historical empirical data. Alternatively, X and Y may be set by determining an average number of samples per repetition for the given label type and multiplying this number by the change in repetition count entered by the user.

If the user takes no corrective action (step 825), the software may use the signal associated with the detected exercise, movement or activity, along with the label and repetition count (step 840), to improve the software's ability (e.g., through machine learning) to detect that particular exercise, movement or activity and repetition count. This way, the next time the user performs a similar activity, the systems and methods will be better able to detect the specific activity performed.

Once a signal, label and repetition count has been selected (step 840), the software prepares the data by smoothing the signal (step 845). Smoothing acts to reduce noise in the input signal (step 840). Smoothing (step 845) may be performed via a variety of methods and options based on the input signal (step 840) and the type of sensors from which the input signal (step 840) is generated. Smoothing methods include, but are not limited to, moving average, Kalman filter, and interpolating spline. The input parameters besides the input signal (step 840) to these smoothing methods may also vary and may be or include, for example, the window size of moving average, the Kalman filter parameters and the number of polynomials when interpolating splines.

Following signal smoothing (step 845), the smoothed signal is split N different ways into N groups of segments (step 850), where N>0. This process is illustrated in FIG. 5. Sensor data input 500 feeds into the splitting algorithm 505, which contains N different methods of splitting the sensor data 500 into segments. The output of a splitting method is a segment group, which includes a list of segments (subsequences of the multivariate input signal). The N splitting methods 505 collectively generate N segment groups 510, where splitting method i generates segment group i, where 0<i<N+1. FIG. 5 illustrates the N segment groups 510, by delineating with vertical lines the input signal. Each sub-sequence of the sensor data between two vertical lines represents a segment in the segment group. The N splitting methods may be or include, for example, fixed distance, Fourier Transform, Short-Time Fourier Transform, Wavelet transform, and/or Peak analysis. The N splitting methods may also be or include multiple versions of the same splitting method, but with varying parameters. For example, fixed distance where the distance is 20, 30, or 40 may be considered three different splitting methods.

Referring again to FIG. 8, following splitting the signal (step 850), the segments from all N segment groups 510 are interpolated (step 855). Interpolation is necessary to prepare the segments for input into a machine learning algorithm (step 865) or clustering algorithm (step 870). Segments are interpolated to a fixed size determined by the nature of the signal and sensors as well as the exercises, movements and activities the software is to detect. For example, if it is known that the set of exercises, movements or activities to be detected have few intricacies, will be short in duration, and no two look alike when the segments are inspected, the interpolation size may be small, such as 40 sample points. If the set is large, unknown beforehand, has elements that may be long in duration, or has data with many unique features that are necessary to differentiate between two segments of different types, the interpolation size may be larger, such as 100 sample points. The primary purpose of interpolating the segments is to standardize the size of the segments (e.g., in length of time or number of data points) as many machine learning algorithms and clustering algorithms require all input data to be of the same size. Interpolation may also, in some cases, allow for faster computations and lower power usage, as using a smaller interpolation size generally requires less processing in later steps, compared to processing required when using a larger interpolation size. Interpolation may be performed via a variety of methods and options. Interpolation methods include but are not limited to linear, polynomial and spline interpolation. A preferred embodiment uses linear interpolation.

Following segment interpolation (step 855), the software checks to see if the label is one that the software is already able to detect (step 860). If this is the case, the segments are passed into a machine learning algorithm to be labeled (step 865). This assists the clustering algorithm (step 870) in clustering correctly. In general, this step requires that the machine learning algorithm already be trained, as described herein, with exercise, movement, or activity data associated with said label. Following the application of labels via machine learning, the segments are input to the clustering algorithm (step 865). If the label is not one that the software is already able to detect, the machine learning labeling step (step 865) is skipped, and the segments are input directly to the clustering algorithm (step 870).

The machine learning step (step 865) requires that the machine learning algorithm (step 865) already be trained with exercise, movement or activity data, as described herein, in order for the exercise, movement or activity to be detected. The machine learning algorithm (step 865) may label segments with the exercise, movement or activity most similar to that segment of data. For each segment input to the machine learning algorithm, the machine learning algorithm provides a label associated with the segment. For example, a number of segments may be input to a machine learning algorithm as a matrix, where each row in the matrix contains data for a different segment. In that case, the machine learning algorithm may output a vector of labels, where each element i in the label vector is associated with row i in the input matrix. Machine learning may be performed via a variety of methods and options. Possible machine learning algorithms include, but are not limited to, K Nearest Neighbors, Simple Vector Machine, and Neural Network. Parameters and options for the selected machine learning algorithm may be determined by the nature of the signal (step 840) and sensors utilized. A preferred embodiment uses a Neural Network machine learning algorithm.

In general, the clustering algorithm (in step 870) acts to find a cluster of sequential segments across the different segment groups that best matches the input repetition count and statistical properties associated with the given label. For example, if the input label were “Lunge” and input repetition count were 10, the clustering algorithm would search each segment group for 10 sequential segments that look the most similar to each other and also fall within the criteria ranges specified for segments with label “Lunge,” such as duration, distance, similarity, and volatility. For example, a segment with duration of 10 seconds would not be selected if the clustering algorithm were looking for 5 sequential repetitions of a “Lunge” where the “Lunge” label has the criterion that a segment must have duration of between 0.5 seconds and 3 seconds. Under optimal circumstances, the clustering algorithm outputs R segments, where R is the input repetition count. If the clustering algorithm cannot find R segments, it will return a smaller number of segments (potentially none) that do meet the label criteria.

Following clustering (step 870), the clustered segments are input into the machine learning algorithm for training (step 875). Machine learning may be performed via a variety of methods and options. Machine learning algorithms include, but are not limited to, K Nearest Neighbors, Simple Vector Machine, and Neural Network. Parameters and options for the selected machine learning algorithm may be determined by the nature of the signal (step 840) and sensors utilized. A preferred embodiment uses a neural network machine learning algorithm. Following machine learning (step 875), the learning process is preferably completed (step 880) for the change the user made. If the user makes another change to the data via an action in the user interface (step 810), this process may be followed once again.

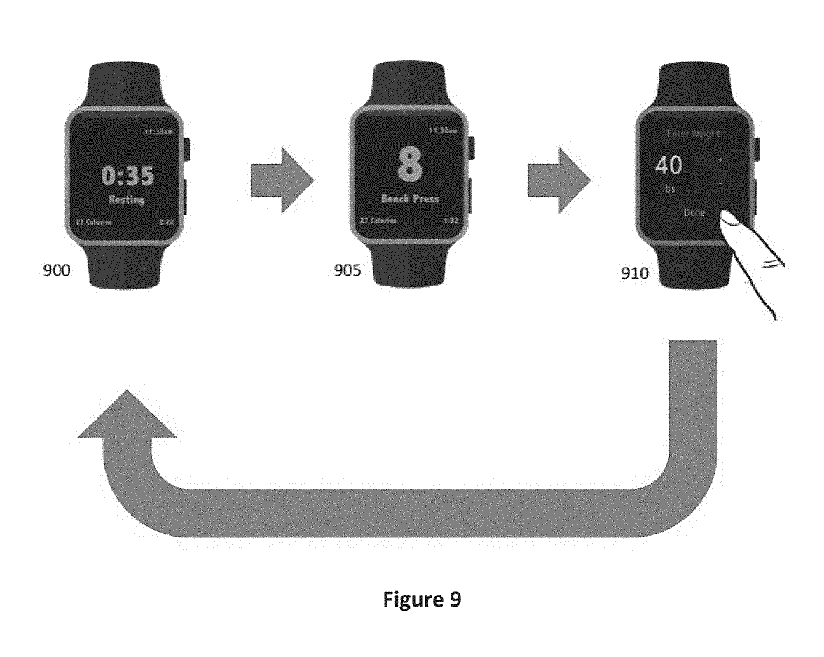

FIG. 9 illustrates one embodiment of a user interface on a wrist worn device with display that accepts touch-based input. This user interface is used to display information to the user and solicit input from the user. In this embodiment, while the systems and methods may not detect an exercise, movement or activity, the device displays resting time along with any other relevant metrics, such as the current time, calorie count and duration since starting the software 900. The resting time is defined as the duration of time between the current time and the end of the previously detected exercise, movement or activity, or, if there was no previously detected exercise, movement or activity, the start of the “workout session” or time since the software started running. Once the systems and methods have detected an exercise, movement or activity, the device displays the name of the exercise, movement or activity along with associated metrics and values, such as repetition count, as illustrated in 905. For purposes of illustration, in FIG. 9, the systems and methods detected eight bench presses. Upon certain events, the systems and methods may prompt the user for input or feedback. In a preferred embodiment, once it has been determined that a set (one or more repetitions) of weight training exercises, movements or activities has been performed and the software determines that the set is complete, the software may prompt the user to input the weight with which they just performed said exercise, movement or activity.

In the embodiment illustrated in FIG. 9, the user is presented with a weight as well as increment and decrement buttons to increase or decrease the displayed weight respectively 910. When the user hits the “Done” button, the weight is processed by the systems and methods, and the resting screen is presented again 900. In one embodiment of the software, the initial weight presented to the user is the last weight with which they performed the current exercise, movement or activity. In the preferred embodiment, if the systems and methods detect an exercise, movement or activity before the user has confirmed a weight, the weight will be automatically confirmed and will immediately display the currently detected item 905.

In one embodiment, the wrist worn wearable makes a noise, vibrates or provides some haptic notification to the user to signal that the software is requesting user input and an input interface is available on the device. In one embodiment, the device solicits input via a voice command asking the user a question (e.g., “What weight did you just lift?”) to which the user can verbally respond and the device or an associated device, such as a smart phone, would use voice recognition techniques to receive the user's input.

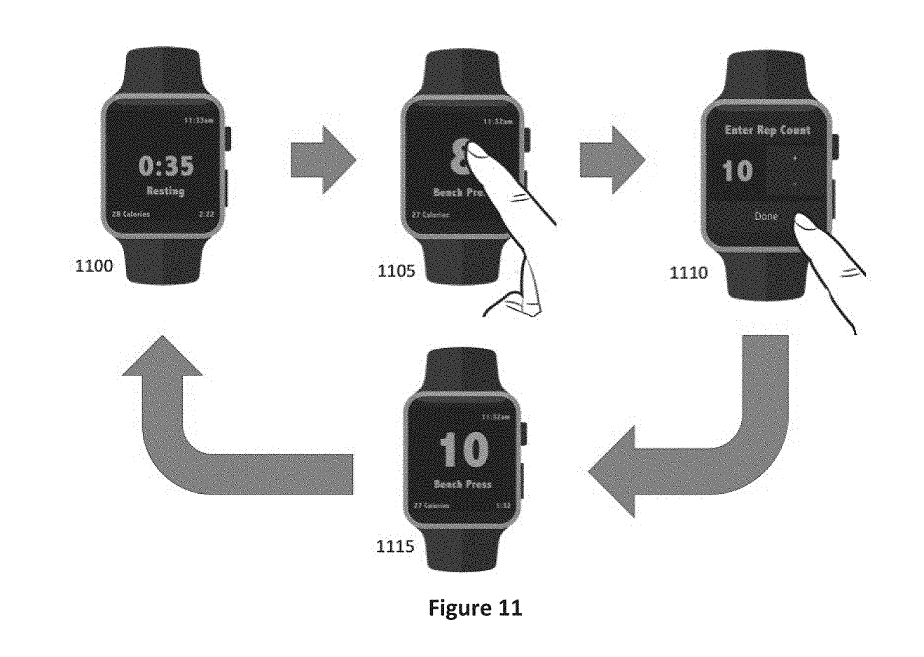

FIG. 11 illustrates a method of modifying data associated with a specific exercise, movement or activity in the preferred embodiment of the user interface on a wrist worn device. While the device is displaying the resting screen 1100, the user may take an action, such as swiping, tapping or long pressing, to indicate to the device that it should display a previously detected item. In the preferred embodiment, the user may swipe to the top and bottom to respectfully navigate and display previous and next items in the timeline 1105. In another embodiment, the user may swipe to the left and right to respectfully navigate and display previous and next items in the timeline. If the user indicates to the user interface 1105 that the user would like to modify a particular item displayed on the screen, such as by tapping or long pressing, a method of input is displayed 1110 with which the user may increment or decrement the current value. Upon tapping “done” the value is processed by the systems and methods, and the associated exercise, movement or activity is displayed with the item as modified (or not) by the user 1115. The user may then navigate back to the resting screen 1100. In the preferred embodiment, if the systems and methods detect an exercise, movement or activity, it will immediately display the item being detected regardless of what else is currently being displayed.

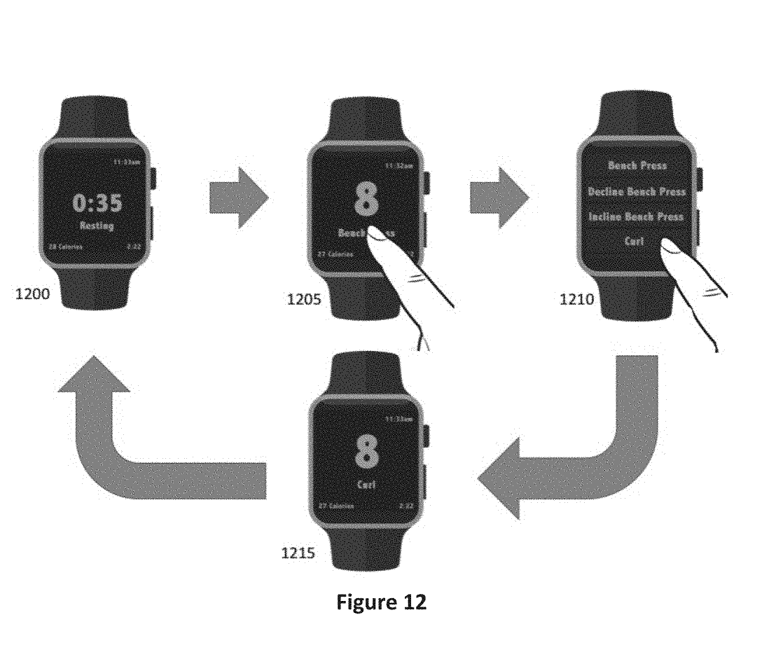

FIG. 12 illustrates a method of modifying the name of a specific exercise, movement or activity in the preferred embodiment of the user interface on a wrist worn device. While the device is displaying the resting screen 1200, the user may take an action, such as swiping, tapping or long pressing, to indicate to the device that it should display a previously detected item. If the user indicates to the user interface 1205 that the user would like to modify the name of the item displayed on the screen, such as by tapping or long pressing, a method of input is displayed 1210 with which the user may select a name from a list. In one embodiment, the user may enter a name via voice recognition. Upon tapping a name, the value is processed by the systems and methods, and the associated exercise, movement or activity is displayed with the item as modified (or not) by the user 1215. The user may then navigate back to the resting screen 1200. In the preferred embodiment, if the systems and methods detect an exercise, movement or activity, the exercise, movement or activity being detected is displayed (e.g., regardless of what else is currently being displayed).

In one embodiment, while the device is displaying a previous timeline item, the user may indicate to the software via a user interface interaction, such as a tap on a button or a swipe, that said timeline item should be deleted, at which point the systems and methods will be notified and the item will be deleted from the timeline.

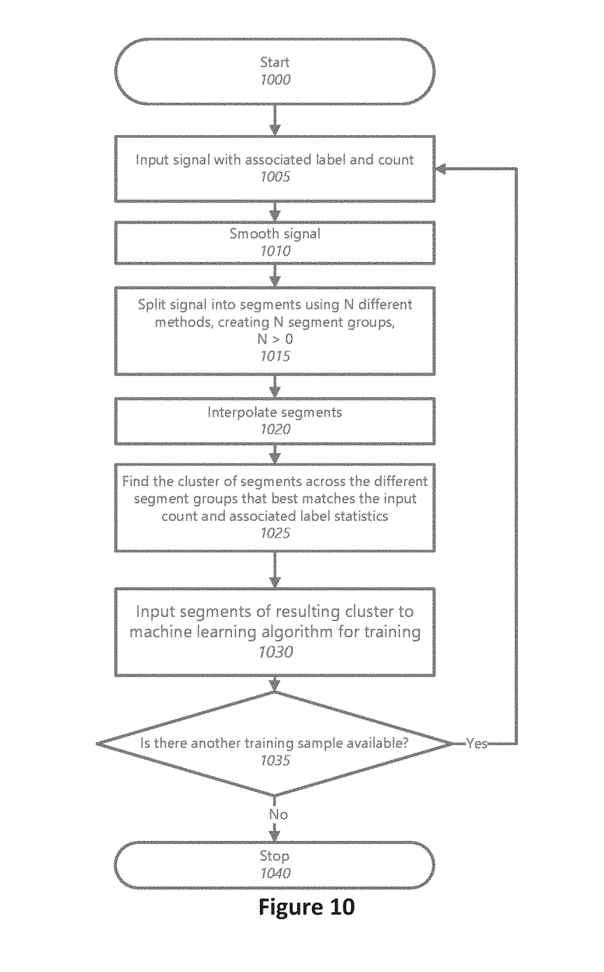

FIG. 10 illustrates a software training process that occurs in order to enable the software to detect an exercise, movement or activity it had not previously been able to detect or to improve the software's ability to detect exercises, movements and activities it already recognizes. In general, “training” and “learning” essentially accomplish the same goal of improving detection accuracy. In various examples, training refers to an initial process of training a machine learning algorithm using a set of training data, as described herein. By contrast, in certain examples, learning refers to a process of improving the machine learning algorithm through the use of feedback received from users of the system. Training is, in general, a more manual process that offers a greater degree of control over how detection for exercises, movements and activities is added or improved upon within the software. For example, during training, system operators could inspect the input signal prior to inputting the signal into the training process and/or could tweak parameters as seen fit. Learning tends to be a more automatic process and is enacted by end user actions and based on user input. Thus, in some implementations, the learning process tends to be more error prone than the training process and may incorporate additional steps, such as step 865 in FIG. 8.

In general, training is a process by which the software may be initially configured to start detecting exercises, movements and activities. The process starts (step 1000), with an input signal, label and repetition count (step 1005). This input is usually generated by having collected data from one or more sensors while a user performs a specific exercise, movement or activity. The label is the label associated with the exercise, movement or activity the user performed (e.g., “Bench Press”). The repetition count is generated by counting how many repetitions a user performed.

Once a signal, label and repetition count are input (step 1005), the software prepares the data by smoothing the signal (step 1010). Smoothing acts to reduce noise in the input signal. Smoothing may be performed via a variety of methods and options based on the input signal and the type of sensors from which the input signal is generated. Smoothing methods include but are not limited to: moving average, Kalman filter, and interpolating spline. The input parameters besides the input signal to these smoothing methods may also vary such as the window size of moving average, the Kalman filter parameters and the number of polynomials when interpolating splines.

Following signal smoothing (step 1010), the smoothed signal is split N different ways into N groups of segments (step 1015), where N>0. This process is illustrated in FIG. 5. The sensor data input 500 feeds into the splitting algorithm 505, which contains N different methods of splitting the sensor data 500 into segments. The output of a splitting method is a segment group, which comprises a list of segments (subsequences of the multivariate input signal). The N splitting methods 505 collectively generate N segment groups 510, where splitting method i generates segment group i, where 0<i<N+1. FIG. 5 illustrates the N segment groups 510, by delineating with vertical lines the input signal. Each sub-sequence of the sensor data between two vertical lines represents a segment in the segment group. The N splitting methods may comprise, but is not limited to, the following: fixed distance, Fourier Transform, Short-Time Fourier Transform, Wavelet transform, and Peak analysis. The N splitting methods may also comprise multiple versions of the same splitting method, but with varying parameters, for example, fixed distance where the distance is 20, 30 or 40 would be considered three different splitting methods.

Referring again to FIG. 10, following splitting the signal (step 1015), the segments from all N segment groups 510 are interpolated (step 1020). Interpolation may be necessary to prepare the segments for input into the clustering algorithm (step 1025). Segments may be interpolated to a fixed size determined by the nature of the signal and sensors as well as the exercises, movements and activities the software is to detect. The primary purpose of interpolating the segments is to standardize the size of the segments (e.g., in length of time or number of data points) as many clustering algorithms require all input data to be of the same size. Interpolation may be performed via a variety of methods and options. Interpolation methods include, but are not limited to, linear, polynomial, and spline interpolation. A preferred embodiment uses linear interpolation.

Following segment interpolation (step 1020), the segments are input to a clustering algorithm. As described herein, the clustering algorithm (step 1025) acts to find a cluster of sequential segments across the different segment groups that best matches the input repetition count and statistical properties associated with the given label.

Following clustering (step 1025), the clustered segments are input into the machine learning algorithm for training (step 1030). Machine learning may be performed via a variety of methods and options. Machine learning algorithms include, but are not limited to, K Nearest Neighbors, Simple Vector Machine, and Neural Network. Parameters and options for the selected machine learning algorithm are determined by the nature of the signal (step 1005) and sensors utilized. A preferred embodiment uses a Neural Network machine learning algorithm.

Following machine learning, the software determines if there is another training sample available for training. This allows for a collection of training samples (signal, label, repetition count triples) to be trained quickly in sequence from a database, file or other data source. If there is at least one more training sample available that has not yet been trained, the process preferably starts again with that training sample (step 1005). If there are no more training samples, the process completes (step 1040).

In certain examples, a system and method are provided for transforming signals from one or more sensors into a list of movements, exercises and/or activities. The systems and methods may learn how to detect new movements, exercises and activities and improve the software's ability to detect movements, exercises and activities it is already able to detect. The systems and methods may be used to track repetitions and sets, as used in fitness training or weight lifting.

In some implementations, a user interface is provided for displaying a list of movements, exercises and activities through which a user may interact with the system in order to correct incorrect data or missing data, allowing the system to utilize user feedback in order to improve the software's detection capabilities and “learn” to detect new movements, exercises and activities. The user interface may be provided, for example, on a wrist worn device with display that allows the user to correct incorrect outputs from the system and feed them back in to the system for “learning.”

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. For example, parallel processing can be used to perform multiple emoji detection methods simultaneously. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A method comprising:
performing by one or more computers:
receiving a signal from one or more sensors attached to an object;
splitting the signal into a plurality of segments, each segment comprising a discrete time interval of the signal;
providing one or more of the segments to a machine learning algorithm trained to recognize specific movements of the object based on the signal; and
receiving from the machine learning algorithm a label for each of the one or more segments, the label comprising an identification of a specific movement of the object.

2. The method of claim 1, wherein the object is a person.

3. The method of claim 2, wherein the one or more sensors are worn by the person.

4. The method of claim 2, wherein the specific movement comprises an exercise performed by the person.

5. The method of claim 1, further comprising determining at least one exercise parameter associated with the plurality of segments, the at least one exercise parameter selected from the group consisting of a number of sets, a number of repetitions, a resting time, and combinations thereof.

6. The method of claim 1, further comprising interpolating the segments to achieve a fixed segment size.

7. The method of claim 1, further comprising filtering the labeled segments.

8. The method of claim 1, further comprising discarding a labeled segment that does not meet criteria for the label associated with the labeled segment.

9. The method of claim 1, further comprising generating a timeline of movements for the object, the timeline comprising at least one label.

10. The method of claim 1, further comprising editing the timeline based on input received from a user.

11. The method of claim 10, further comprising using the input received from the user to train the machine learning algorithm.

12. The method of claim 1, further comprising training the machine learning algorithm with data from at least one sensor, the data being associated with a plurality of movements of the object.

13. The method of claim 1, wherein providing one or more of the segments comprises generating a feature vector for a segment and providing the feature vector to a machine learning algorithm, and wherein the machine learning algorithm is trained to recognize specific movements of the object based on the feature vector.

14. A system comprising:
one or more computers programmed to perform operations comprising:
receiving a signal from one or more sensors attached to an object;
splitting the signal into a plurality of segments, each segment comprising a discrete time interval of the signal;
providing one or more of the segments to a machine learning algorithm trained to recognize specific movements of the object based on the signal; and
receiving from the machine learning algorithm a label for each of the one or more segments, the label comprising an identification of a specific movement of the object.

15. A storage device having instructions stored thereon that when executed by one or more computers perform operations comprising:
receiving a signal from one or more sensors attached to an object;
splitting the signal into a plurality of segments, each segment comprising a discrete time interval of the signal;
providing one or more of the segments to a machine learning algorithm trained to recognize specific movements of the object based on the signal; and
receiving from the machine learning algorithm a label for each of the one or more segments, the label comprising an identification of a specific movement of the object.
